(19) United States
(12) Patent Application Publication
(10) Pub. No.: US 2001/0033729 A1
(43) Pub. Date: Oct. 25, 2001

(54) Hermetically sealed optical fiber assembly and method of manufacturing the same

(76) Inventor: Toshiaki Kuroha, Yokohama-shi (JP)

Correspondence Address: VENABLE, BAETJER, HOWARD & CIVILETTI, LLP,, P.O. Box 34385, Washington, DC, 20043-9998, US

(21) Appl. No.: 09/776,773

(22) Filed: Feb. 6, 2001

(30) Foreign Application Priority Data
Apr. 19, 2000 (JP) 2000-117374

(51) Int. Cl. G02B 6/44

(52) U.S. Cl. 385/138

(57) ABSTRACT

A hermetically sealed optical fiber assembly according to the present invention includes an optical fiber having a metallic coating on at least one intermediate part thereof which is exposed by removing part of a coating on the optical fiber, a hermetic connecting component made of metal which receives the metallic coated part therein, and a brazing part for tightly fixing the metallic coated part of the optical fiber to an inner wall of the metal hermetic connecting component.

### BACKGROUND OF THE INVENTION

1. Field of the Invention

The present invention relates to an optical fiber with a hermetic sealing part appropriate for forming a hermetic structure of a parallel optical transmission module using an optical fiber array, and to the manufacturing method thereof.

2. Description of the Related Art

With respect to a single-core optical fiber, several proposals have been made for a hermetic structure that is necessary when extracting the optical fiber from a container in which airtightness must be maintained. In the case of the single-core optical fiber, after two hermetic ferrules have been inserted into a fiber terminal, the optical fiber can easily be attached to the hermetic ferrules. In “Air tight optical adapter” disclosed in Japanese Unexamined Patent Application Publication No. 8-211232, another structure is proposed. That is, the surface of the optical fiber is subjected to metallic coating, is inserted into an insertion hole of a flange part, and is then sealed by a brazing filler metal such as solder or silver solder.

In the case of a multi-core optical fiber, since it is necessary to adjust and fix a top end thereof to a V-groove substrate or the like in a hermetic space, a problem occurs in that soldering must be performed in an arrayed state to realize the hermetic structure. The multi-core array optical fibers are one essential component for a parallel transmission module in high-density transmission; such as connection module with a planar waveguide or coupling module with an array of light-emitting elements. When the entire tape fiber terminal that is ahead of a hermetic part (sealed part) is subjected to metallic coating, this creates problems in that fluctuation of the thickness of the metallic coating of a part fixed in the V groove affects the accuracy of the array.

It is assumed that, as shown in FIG. 9, a coated part 30 of a tape optical fiber is removed and metallic coated parts 31a, 31b, 31c, and 31d of optical-fiber cores are provided at tips of the optical fibers. The tape optical fiber is put in a hermetic connecting component 21 and sealed by soldering in a sealed space. The tips are joined with a V-groove array 22, however, there is a risk that the shape of the metallic coated parts 31a, 31b, 31c, and 31d of the optical-fiber cores, an increase in rigidity due to the coating, and the like, may prevent an ideal joint. Only part of a case 20 is illustrated. The V-groove array 22 is provided in the case 20. The case 20 and the hermetic connecting component 21, and the hermetic connecting component 21 and the coated part 30 of the tape optical fiber are sealed by sealing adhesives (for example, epoxy resins) 25 and 26, respectively.

FIG. 10 is a plan sectional view for explaining problems arising when metallic coating is applied to the tips of the cores of the tape optical fiber in another structure. This example shows a case where the coated part 30 of the tape optical fiber is directly adhered to the case 20 with a sealing adhesive (for example, epoxy resin) 27. With such a sealing adhesive, high sealing accuracy cannot be realized. Although a similar problem occurs with respect to a sealing adhesive 15 as shown in FIG. 8, the sealing in FIG. 8 is better because sealing by soldering is performed.

### SUMMARY OF THE INVENTION

An object of the present invention is therefore to provide a tape optical fiber having a hermetic sealing part in which a hermetic connecting part is previously provided at an intermediate part of the optical fiber, and the manufacturing method thereof.

A more specific object of the present invention is to provide a tape optical fiber having a hermetic sealing part in which, after coating of an intermediate part of the tape fiber has been removed and the exposed fiber part has been subjected to plating, the metallic coated part of the optical fiber is fixed to a hermetic component by brazing using solder, silver solder, or the like, and the manufacturing method thereof.

In order to achieve the above objects, a hermetically sealed optical fiber assembly according to the present invention includes an optical fiber having a metallic coating on at least one intermediate part thereof which is exposed by removing part of a coating on the optical fiber, a hermetic connecting component made of metal which receives the metallic coated part therein, and a brazing part for tightly fixing the metallic coated part of the optical fiber to an inner wall of the metal hermetic connecting component.

In the hermetically sealed optical fiber assembly, a plurality of the optical fibers are provided, forming a multi-core tape optical fiber, the metal hermetic connecting component includes an insertion hole for receiving the coated part of the tape optical fiber and a window provided at a position corresponding to the metallic coated part of the tape optical fiber when the tape optical fiber is inserted into the insertion hole, and the brazing part for tightly fixing the metallic coated part of the optical fiber to the inner wall of the metal hermetic connoting component seals the window.

In the hermetically sealed optical fiber assembly, the optical fiber includes a single-core optical fiber, the metal hermetic connecting component includes a conduit having an inner diameter capable of receiving the coated part of the optical fiber, and the brazing part for tightly fixing the metallic coated part of the optical fiber to the inner wall of the metal hermetic connecting component is provided in the conduit.

The hermetically sealed optical fiber assembly accroding to the present invention further invcludes a cover for the metal hermetic connecting component, the cover being provided with an escape port for the brazing part.

A manufacturing method for a hermetically sealed optical fiber assembly according to the present invention includes the steps of forming a metallic coated part on at least one optical fiber, inserting an exposed part of the optical fiber which has been subjected to the metallic coating into a metal hermetic connecting component, and forming a brazed part between the metallic coated part and an inner wall of the hermetic connecting component, wherein, the step of forming the metallic coated part further includes the steps of removing the coated part of the optical fiber to expose the core thereof, dipping the exposed optical fiber in a sensitizer solution and adsorbing Sn²⁺ in a surface thereof that is made hydrophilic, dipping the optical fiber in an activator solution after washing with water to deposit Pd nuclei by a redox reaction, dipping the optical fiber in an electroless plating solution to form an electroconductive film, and performing electroplating using an electrolyte.

### BRIEF DESCRIPTION OF THE DRAWINGS

FIG. 1 is a plan view showing an embodiment of a tape optical fiber having a hermetic sealing part according to the present invention;

FIG. 2 is a plan view of a hermetic connecting component for airtightly connecting the tape optical fiber shown in FIG. 1;

FIG. 3 is a cross sectional view of the hermetic connecting component shown in FIG. 2;

FIG. 4 is a plan view showing a state in which the tape optical fiber shown in FIG. 1 is inserted into the hermetic connecting component shown in FIG. 2 and FIG. 3;

FIG. 5 is a cross sectional view showing the state in which the tape optical fiber shown in FIG. 1 is inserted into the hermetic connecting component shown in FIG. 2 and FIG. 3;

FIG. 6 is a cross sectional view showing a state in which the tape optical fiber shown in FIG. 1 is inserted into the hermetic connecting component shown in FIG. 2 and FIG. 3, to which solder and a sealing adhesive are applied, and in which the tip of the tape optical fiber is connected to a V-groove array;

FIG. 7 is a cross sectional view showing a state in which the assembly shown in FIG. 6 is connected to a sealing case;

FIG. 8 is a cross sectional view showing a state in which another embodiment of the optical fiber having the hermetic sealing part according to the present invention is connected to a sealing case;

FIG. 9 is a plan sectional view for explaining problems arising when metallic coating is performed at tips of cores of a tape optical fiber; and

FIG. 10 is a plan sectional view showing another structure for explaining other problems arising when metallic coating is performed at the tips of the cores of the tape optical fiber.

### DESCRIPTION OF THE PREFERRED EMBODIMENTS

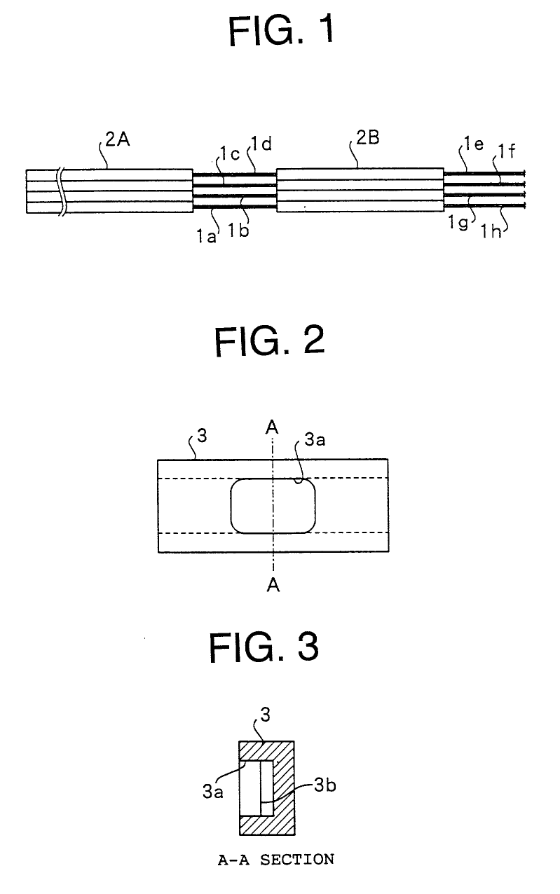

Embodiments of the device according to the present invention will now be described with reference to the drawings. FIG. 1 is a plan view showing an embodiment of a tape optical fiber having a hermetic sealing part according to the present invention. FIG. 2 is a plan view of a hermetic connecting component for airtightly connecting the tape optical fiber shown in FIG. 1. FIG. 3 is a cross sectional view of the hermetic connecting component shown in FIG. 2. Part of a coating of the tape optical fiber (coating between a base-side coated part 2A of the tape optical fiber and a tip-side coated part 2B of the tape optical fiber) is removed and metallic coated parts 1a, 1b, 1c, and 1d are formed on cores of the optical fibers thereof. Metallic coated parts are not formed at tip connecting parts 1e, 1f, 1g, and 1h of the optical-fiber core wires that is ahead of the coating 2B.

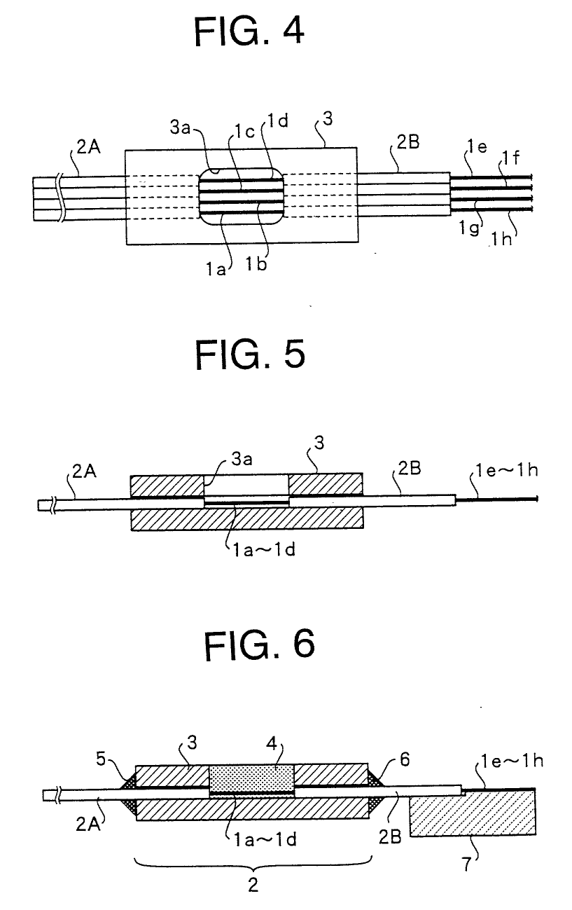

A hermetic connecting component 3 is, as shown in FIG. 2 and FIG. 3, provided with an insertion hole 3b for receiving the tape optical fiber shown in FIG. 1, on which a window part 3a is provided. FIG. 4 and FIG. 5 illustrate a state in which the tape optical fiber shown in FIG. 1 is inserted into the hermetic connecting component shown in FIG. 2 and FIG. 3. The metallic coated parts 1a, 1b, 1c, and 1d are inserted to a position which corresponds to the window part 3a.

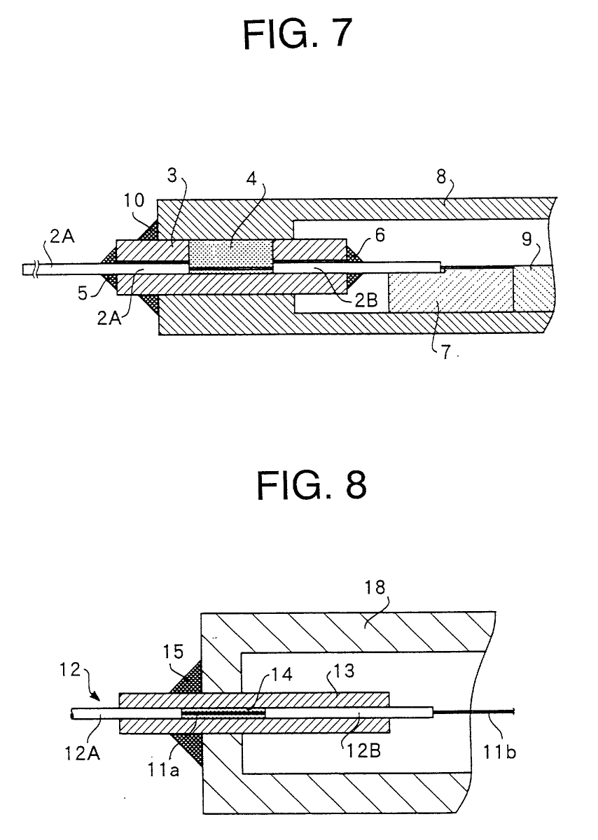

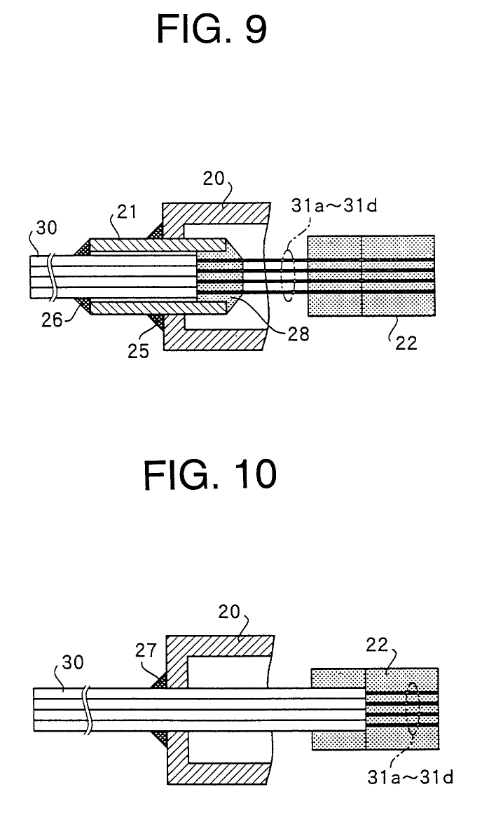

FIG. 6 illustrates a state in which the tape optical fiber shown in FIG. 1 is inserted into the hermetic connecting component 3 shown in FIG. 2 and FIG. 3, the metallic coated parts 1a, 1b, 1c, and 1d are fixed by a solder 4, and the hermetic connecting component 3 and the coated part 2A are fixed together with a sealing adhesive 5, and the hermetic connecting component 3 and the coated part 2B are fixed together by a sealing adhesive 6. FIG. 6 also shows a state in which the tip connecting parts 1e, 1f, 1g, and 1h of the tape optical fiber are connected to a V-groove array 7. FIG. 7 is a cross sectional view illustrating a state in which the assembly shown in FIG. 6 is connected to a sealing case 8. The V-groove array 7 and a waveguide 9 are disposed in the case 8. The tip connecting parts 1e, 1f, 1g, and 1h of the tape optical fiber are adhered to the waveguide 9. The hermetic connecting component 3 is tightly adhered to the case 8 with a sealing adhesive 10.

FIG. 8 is a cross sectional view illustrating a state in which another embodiment of the optical fiber having a hermetic sealing part according to the present invention is connected to the sealing case. The embodiment relates to a single-core optical fiber. Coating of a single-core optical fiber 12 is removed at a tip and an intermediate part thereof. A metallic coated part 11a is formed on a core part between coated parts 12A and 12B. The metallic coating is not formed at a tip connecting part 11b of the optical-fiber core. The single-core optical fiber 12 is inserted into a metallic conduit 13. In this instance, a small piece or powder of solder or brazing metal is inserted between the coated parts 12A and 12B, and then welded by external heating to form a sealed part with a solder 14. In addition, a window can be provided at an intermediate part of the conduit as in the previous embodiment.

In the assembly of the metallic conduit 13 and the optical fiber 12, which is formed as described above, the tip connecting part 11b of the optical fiber core, which is not coated is inserted into a case 18, and the metallic conduit 13 and the case 18 are sealed by a sealing adhesive 15 such as an epoxy resin.

### EXAMPLES

A manufacturing method of the tape optical fiber as shown in FIG. 1 will be principally described with reference to an example.

### Example 1

A 5 mm length of coating at an intermediate part of an eight-core tape constructed with single-mode optical fiber for 1.3 μm was removed.

The optical fiber at a part exposed by removing the coating was dipped in a sensitizer solution and Sn²⁺ was adsorbed to the surface thereof that was made hydrophilic.

After washing with water, the optical fiber was dipped in an activator solution to deposit Pd crystal nuclei by a redox reaction.

After washing with water and drying, the optical fiber was dipped in an electroless nickel-plating solution for two minutes to form an electroconductive film of 0.5 to 1.0 μm in thickness.

The optical fiber was subjected to electroplating at a current density of 5 A/dm² for three minutes using a nickel sulfamate electrolyte, and further at a current density of 0.5 A/dm² for two minutes using a cyanide-free gold plating solution.

An intermediate part of a metallic-coated tape optical fiber (FIG. 1) so obtained was inserted into the metallic hermetic connecting component 3 shown in FIG. 2 and FIG. 3. A tin-lead eutectic solder piece was added through the window part 3a and heated via a metal cover to weld and fasten the solder.

A helium test of the optical fiber having the hermetic sealing part obtained in Example 1 was performed, and resulted in the leak rate of 10⁻⁷ cc/sec or less.

Next, a manufacturing method of the optical fiber shown in FIG. 8 will be mainly described with reference to an example.

### Example 2

Coating of an intermediate part of 5 mm in length of a single-mode optical fiber for 1.3 μm having a coating with an outside diameter of 250 μm was removed.

The optical fiber part exposed by removing the coating part was dipped in a sensitizer solution and Sn²⁺ was adsorbed to a surface thereof that was made hydrophilic.

After washing with water, it was dipped in an activator solution to deposit Pd crystal nuclei by a redox reaction.

After washing with water and drying, it was dipped in an electroless nickel-plating solution for two minutes to form an electroconductive film of 0.5 to 1.0 μm in thickness.

The fiber was subjected to electroplating at a current density of 5 A/dm² for three minutes using nickel sulfamate electrolyte, and further at a current density of 0.5 A/dm² for two minutes using a cyanide-free gold plating solution.

An intermediate part of the metallic-coated optical fiber so obtained was inserted into a metallic conduit 13 (the outside diameter was 1 mm and the inside diameter was 0.3 mm), as shown in FIG. 8, and subsequently, a gold-tin solder piece was added and heated to weld the solder, thereby fixing the metallic-coated optical fiber to the metallic conduit.

As a result of a helium test of the optical fiber having the hermetic sealing part obtained in Example 2, it was determined that the leak rate was 10⁻⁷ cc/sec or less.

In the optical fiber having the hermetic sealing part according to the present invention, as described above, the coating at the intermediate part of the optical fiber is removed, and the exposed fiber part is subjected to plating, and then the optical fiber at the metallic coated part is brazed to the hermetic component using the solder or the silver solder. This structure can be applied to single-core optical fibers or tape optical fibers, and can realize a highly hermetically sealed device. The metallic coated part can be provided by electroless plating or plating.

What is claimed is:

1. A hermetically sealed optical fiber assembly comprising:
an optical fiber having a metallic coating on at least one intermediate part thereof which is exposed by removing part of a coating on the optical fiber;
a hermetic connecting component made of metal which receives the metallic coated part therein; and
a brazing part for tightly fixing the metallic coated part of the optical fiber to an inner wall of the metal hermetic connecting component.

2. A hermetically sealed optical fiber assembly according to claim 1, wherein:
a plurality of the optical fibers are provided, constituting a tape optical fiber;
the metal hermetic connecting component comprises an insertion hole for receiving the coated part of the tape optical fiber and a window provided at a position corresponding to the metallic coated part of the tape optical fiber when the tape optical fiber is inserted into said insertion hole; and
the brazing part for tightly fixing the metallic coated part of the optical fiber to the inner wall of the metal hermetic connecting component seals the window.

3. A hermetically sealed optical fiber assembly according to claim 1, wherein:
the optical fiber comprises a single-core optical fiber;
the metal hermetic connecting component comprises a conduit having an inner diameter capable of receiving the coated part of the optical fiber; and
the brazing part for tightly fixing the metallic coated part of the optical fiber to the inner wall of the metal hermetic connecting component is provided in the conduit.

4. A hermetically sealed optical fiber assembly according to claim 2, further comprising a cover for said metal hermetic connecting component, said cover being provided with an escape port for the brazing part.

5. A manufacturing method for a hermetically sealed optical fiber assembly, said method comprising the steps of:
forming a metallic coated part on at least one optical fiber;
inserting an exposed part of the optical fiber which has been subjected to the metallic coating into a metal hermetic connecting component; and
forming a brazed part between the metallic coated part and an inner wall of the hermetic connecting component;
wherein, said step of forming the metallic coated part further comprises the steps of:
removing the coated part of the optical fiber to expose the core thereof;
dipping the exposed optical fiber in a sensitizer solution and adsorbing Sn²⁺ in a surface thereof that is made hydrophilic;
dipping the optical fiber in an activator solution after washing with water to deposit Pd nuclei by a redox reaction;
dipping the optical fiber in an electroless plating solution to form an electroconductive film; and
performing electroplating using an electrolyte.
